(19) United States
(12) Patent Application Publication
(10) Pub. No.: US 2025/0175006 A1
(43) Pub. Date: May 29, 2025

(54) NETWORK RECONFIGURATION AND EFFECTIVE LOAD CARRYING CAPABILITY QUANTIFICATION TO ENHANCE GRID RESILIENCE

(71) Applicant: University of Connecticut, Farmington, CT (US)

(72) Inventor: Zongjie Wang, Storrs, CT (US)

(21) Appl. No.: 18/961,823

(22) Filed: Nov. 27, 2024

Related U.S. Application Data
(60) Provisional application No. 63/602,936, filed on Nov. 27, 2023.

(51) Int. Cl. H02J 3/38; G05B 13/02; H02J 13/00

(52) U.S. Cl. CPC H02J 3/38; G05B 13/027; H02J 13/00002; H02J 2203/20; H02J 2300/10; H02J 2300/24; H02J 2300/28

(57) ABSTRACT

A system for modifying an electric grid having electrical components includes a processor for executing instructions. The instructions include: generating a mesh-view map of the electric grid with mesh grid lines forming cells, each electrical component being represented in a corresponding cell; plotting a disturbance event on the map to provide a disturbance modified map having one or more disturbance event parameters; generating a plurality of scenarios affecting the electric grid using the disturbance modified map based on uncertainty of various parameters of the electric grid and the disturbance event; developing a plan to modify the electric grid to optimize economics of operation and resilience of the electric grid, and carbon emission from electrical generation using the plurality of scenarios and the disturbance modified map. The system also includes a grid manipulator device configured to modify the electric grid in response to receiving a signal from the processor.

### BACKGROUND OF THE INVENTION

### 1. Field of the Invention

The invention disclosed herein relates to power system resilience and grid management in electric distribution networks. In particular, the invention relates to integrating intelligent systems and artificial intelligence (AI) technologies to improve grid adaptability and operational performance during extreme events.

### 2. Description of the Related Art

Current technology for managing electric grids primarily focuses on balancing supply and demand of electricity in an efficient, reliable, and sustainable manner. These systems typically incorporate various elements such as distributed energy resources (DERs), smart grid technologies, and predictive analytics.

DERs, which include solar panels, wind turbines, and energy storage systems, are increasingly integrated into the electric grid. These resources aid in decentralizing the generation of electricity, thereby enhancing grid resilience. However, the current integration methods often lack real-time optimization capabilities, leading to inefficiencies in energy distribution and usage. Grid management is further complicated by the sporadic production of these resources.

Modern electric grids increasingly employ smart grid technologies, encompassing advanced metering infrastructure, grid automation, and demand response systems. While these technologies offer improved grid management and customer engagement, they often fall short in dynamically adapting to rapidly changing conditions such as weather variations and unexpected demand spikes.

Predictive analytics in grid management use historical data and algorithms to forecast demand and supply patterns. Although beneficial in planning, these systems generally lack the ability to adapt in real-time to unforeseen circumstances, limiting their effectiveness in managing acute grid stresses.

The increasing frequency of extreme weather events due to climate change poses a significant challenge to grid stability. Existing systems are often not equipped to handle the heightened levels of unpredictability and the rapid fluctuations in energy supply and demand caused by these events.

Further, current grid management systems struggle to adapt to sudden outages and shifting energy demand patterns. This is particularly evident in scenarios where there is a rapid transition from traditional energy sources to renewable sources, which are inherently variable in nature.

In short, present-day systems often fall short in real-time optimization, adaptability to changing conditions, and comprehensive integration of AI technologies.

Therefore, a need exists for an intelligent system that leverages AI for optimized, real-time network management, dynamically adapting to external factors such as weather changes, climate impacts, and shifting energy demands.

### SUMMARY

Disclosed is a system for modifying an electric grid having electrical components. The system includes a processor configured to execute instructions stored on a non-transitory medium. The instructions implement a method including: generating a mesh-view map of the electric grid, the mesh-view map having mesh grid lines forming cells, each electrical component being represented as a type of electrical component and in a corresponding cell; plotting a disturbance event on the mesh-view map to provide a disturbance modified mesh-view map, the disturbance modified mesh-view map having one or more parameters of the disturbance event; generating a plurality of scenarios affecting the electric grid using the disturbance modified mesh-view map based on uncertainty of various parameters of the electric grid and the disturbance event; and developing a plan to modify the electric grid, the plan optimizing economics of operation of the electric grid, resilience of the electric grid, and carbon emission from electrical generation for the electric grid using the plurality of scenarios and the disturbance modified mesh-view map. The also includes a grid manipulator device configured to modify the electric grid in response to receiving a signal from the processor to implement the plan.

Also disclosed is a non-transitory computer readable medium having instructions for modifying an electric grid having electrical components that when executed by a processor implements a method. The method includes: generating a mesh-view map of the electric grid, the mesh-view map having mesh grid lines forming cells, each electrical component being represented as a type of electrical component and in a corresponding cell; plotting a disturbance event on the mesh-view grid map to provide a disturbance modified mesh-view grid map, the disturbance modified mesh-view grid map having one or more parameters of the disturbance event; generating a plurality of scenarios affecting the electric grid using the disturbance modified mesh-view grid map based on uncertainty of various parameters of the electric grid and the disturbance event; and developing a plan to modify the electric grid, the plan optimizing economics of operation of the electric grid, resilience of the electric grid, and carbon emission from electrical generation for the electric grid using the plurality of scenarios and the disturbance modified mesh-view map. The method also includes transmitting a signal to a grid manipulator device to implement the plan, wherein the signal controls the grid manipulator device to modify the electric grid.

Further disclosed is a system for modifying an electric grid having electrical components. The system includes a processor configured to execute instructions stored on a non-transitory medium. The instructions implement a method including: generating a mesh-view map of the electric grid, the mesh-view map having mesh grid lines forming cells, each electrical component being represented as a type of electrical component and in a corresponding cell; plotting a disturbance event on the mesh-view grid map to provide a disturbance modified mesh-view grid map, the disturbance modified mesh-view grid map having one or more parameters of the disturbance event; and developing a plan to modify the electric grid, the plan optimizing economics of the operation of the electric grid, resilience of the electric grid, and carbon emission of electrical generation for the electric grid using the disturbance modified mesh-view map. The system also includes a controller in communication with the processor and configured to transmit a control signal to at least one of a grid manipulator or a distributed energy resource to implement the plan. The system further includes a sensor in communication with the processor and configured to sense a parameter related to at least one of any electrical component in the electric grid or the disturbance event to provide feedback as to operation of the electric grid or risk to operation of the electric grid.

### BRIEF DESCRIPTION OF THE DRAWINGS

The following descriptions should not be considered limiting in any way. With reference to the accompanying drawings, like elements are numbered alike:

FIG. 1 depicts aspects of a system architecture for managing an electric grid;

FIG. 2 is a flow chart for a method for managing the electric grid;

FIG. 3 depicts aspects of overlaying grid lines on a map of an electric grid indicating locations of electrical components to provide a mesh-view grid map;

FIG. 4 depicts aspects of a disturbance event moving through an area of an electric grid illustrated on a mesh-view grid map;

FIG. 5 depicts aspects of various disturbance events in an electric grid area illustrated on a mesh-view grid map;

FIGS. 6A-6D, collectively referred to as FIG. 6, depict aspects of how various electric grid disturbance events are illustrated on a mesh-view grid map;

FIG. 7 is a flowchart for a method for generating various electric grid scenarios in response to an electric grid disturbance; and

FIG. 8 is a flowchart for a method for modifying an electric grid in response to a predicted or actual electric grid disturbance.

### DETAILED DESCRIPTION OF THE INVENTION

Disclosed herein are embodiments of an advanced framework designed to integrate Distributed Energy Resources (DERs) within Energy Communities (ECs). The technology disclosed provides for enhanced grid resilience in situations of extreme events such as storms, hurricanes, or power outages, while simultaneously promoting economic efficiency and reducing carbon emissions. This innovation helps to reduce impact of high-impact low-probability (HILP) events, which are increasingly prevalent due to climate change and drive a need for robust and adaptive power systems. The framework is implemented with respect to an electric grid to improve the operation and resilience of the electric grid.

Generally, the term “electric grid” relates to a system that provides electricity to customers. The system may include generation units, energy storage units, and transmission and distribution equipment such as provided by a local utility for instance.

Generally, the framework (which may also be referred to as a “model”) addresses several challenges in modern power systems such as:
Resilience During Extreme Events: The framework enhances grid resilience by effectively managing and distributing energy resources during extreme weather events or other disruptions. By utilizing DERs, the dependency on vulnerable power lines is reduced, thus improving the system's ability to withstand and recover from disruptive events.
Economic Efficiency: The model integrates a two-stage economic-resilience scheduling (TSERS) framework that optimizes both the operational costs and the social welfare. This dual focus ensures not only the economic viability of ECs but also maximizes the benefits for all stakeholders involved, including distribution system operators (DSOs) and end-user customers.
Carbon Emission Reduction: In line with global sustainability goals, the invention incorporates carbon emission-related constraints into the scheduling framework. This approach is instrumental in transitioning towards a decarbonized energy future by minimizing the reliance on fossil fuels and promoting the integration of renewable energy sources.
Adaptability to Climate Change: The invention recognizes the challenges posed by climate change and integrates strategies to enhance grid adaptability in response to evolving environmental conditions.
Optimization of Demand Response Strategies: By optimizing demand response strategies, the invention contributes to a more balanced and efficient energy distribution, particularly during peak demand periods or emergencies.

Embodiments include an algorithm that leverages network topology-based optimization to integrate economic and resilience metrics within ECs. This is achieved through the following:
Effective Load-Carrying Capability (ELCC) Quantification: The model incorporates the ELCC of renewable sources to measure the incremental load these sources can consistently support, enhancing grid resilience.
Pareto Front of Non-dominated Solutions: The algorithm extracts a Pareto front of non-dominated solutions for the proposed multi-objective optimization problem, providing a comprehensive visualization of the trade-offs between economic efficiency, resilience, and emission objectives.
Mesh-view Grid Mapping Structure: An innovative mesh-view grid mapping structure evaluates EC model behavior during extreme events, allowing for a detailed assessment of resilience.
Carbon Emission Constraints Integration: The framework integrates carbon emission constraints within the operational constraints of the system, aligning with environmental sustainability goals.
Stochastic Scheduling Model: The model accounts for uncertainties in renewable generation, market prices, and event characteristics to provide realistic and robust solutions.

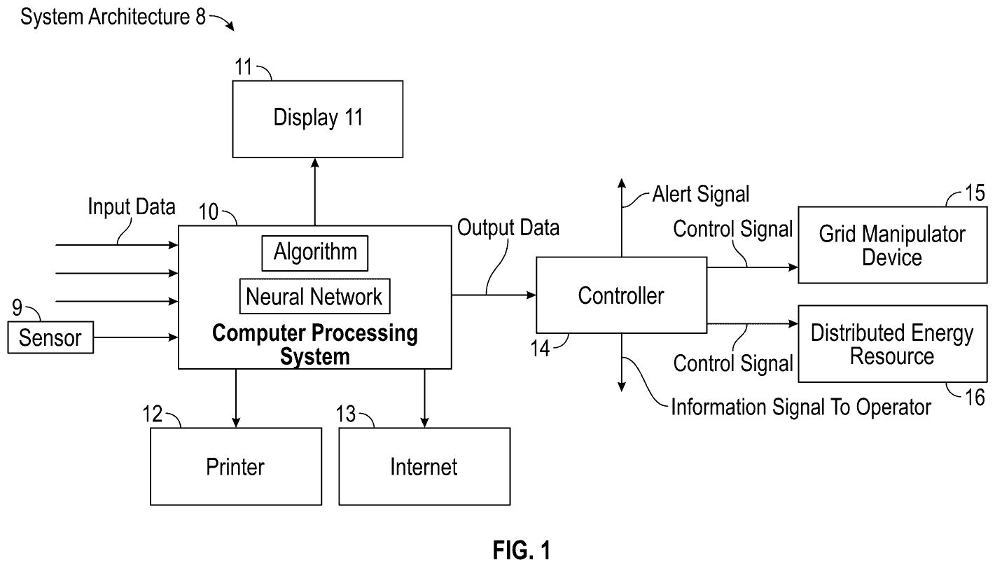

FIG. 1 depicts aspects of an example of a system architecture 8 for implementing the technology described herein. The system architecture 8, which may also be referred to as an “electric grid management system”, includes a computer processing system 10 that includes a processor for executing an algorithm and related software. The term “framework” as used herein relates to the algorithms and software that are executed by the computer processing system 10. The framework is inclusive of mathematical models used in various aspects of the disclosure. The algorithm and software may be stored on a non-transitory medium in the computer processing system 10 and/or remotely, such as in a cloud-based storage medium. The computer processing system 10 includes input interfaces configured for receiving input data. At least some of the input data may be provided by a sensor 9. The sensor 9 may represent a plurality of sensors distributed throughout the electric grid, configured to monitor operational data related to electric grid operations. The operational data may include voltage levels, power flows, equipment status (e.g., operational or not operational), and environmental parameters (e.g., temperature, humidity, wind speed) as non-limiting examples. The input data may also be provided by a Supervisory Control And Data Acquisition (SCADA) system, database connections, and/or external sources such as weather services. Data that is dynamic or subject to change is generally obtained in real time. Accordingly, the sensed operational data may be used to provide real time feedback as to the current operational status of the electric grid. The processor in the computer processing system 10 may also implement a neural network stored on a non-transitory medium. The neural network is trained to implement AI and machine-learning tools for performing aspects of the technology disclosed herein. The neural network includes an input layer for receiving input data and an output layer for outputting output data. Between the input layer and the output layer are hidden layers. Historic input data is used to train the neural network and the neural network makes a prediction or classification as output data based on current or real time input data. The current or real time input data may also be used to check or verify the accuracy of the prediction or classification. The neural network can be modified or updated by adjusting weights used in the various layers to improve the accuracy of the neural network. Accordingly, the current or real time input data can also be used to train the neural network in real time so that the neural network can provide the most up-to-date predictions or classifications. Continually training and updating the neural network is inherently included in the technology disclosed herein.

The computer processing system 10 also includes output interfaces configured for outputting information or data provided by the framework. The outputted information or data may be provided to a display 11, a printer 12, the internet 13, and/or a controller 14 as non-limiting examples. The controller 14 is configured to act on the information or data provided by the framework to control a grid manipulator device 15 and/or a distributed energy resource 16 in accordance with the framework algorithm. The grid manipulator device 15 is any one or more devices that are configured to control or modify aspects of the electric grid upon receiving a signal. For example, the grid manipulator device 15 may be configured to connect or disconnect portions of the electric grid from the overall electric grid using remote-controlled switchgear as a non-limiting example. As another example, the grid manipulator device 15 may also be configured to integrate standby generation sources (e.g., generators, battery storage devices, pumped hydro-power storage) into the grid using remote-controlled switchgear. As another example, the grid manipulator device 15 may be configured to remotely change transformer settings or taps to remotely control voltage settings. Thus, in non-limiting embodiments, the grid manipulator device 15 may include remote-controlled switchgear, remote-controlled actuators, remote-controlled electronics, or other associated devices for remotely controlling or modifying the electric grid. The distributed energy resource 16 is any one or more of various electrical energy resources (e.g., wind turbines, solar panels) that are distributed throughout the electrical grid. In one or more embodiments, the framework can provide for connecting distributed energy resources to the electrical grid when those resources are available and disconnecting fossil-fuel generation when the fossil-fuel generation can be displaced by non-fossil-fuel energy sources. In other words, when distributed energy sources are available with a known capacity, then fossil-fueled generation having the same or less capacity can be disconnected from the electric grid, thus eliminating the associated emission of carbon into the atmosphere. In one or more embodiments, the controller 14 may be incorporated into the computer processing system 10.

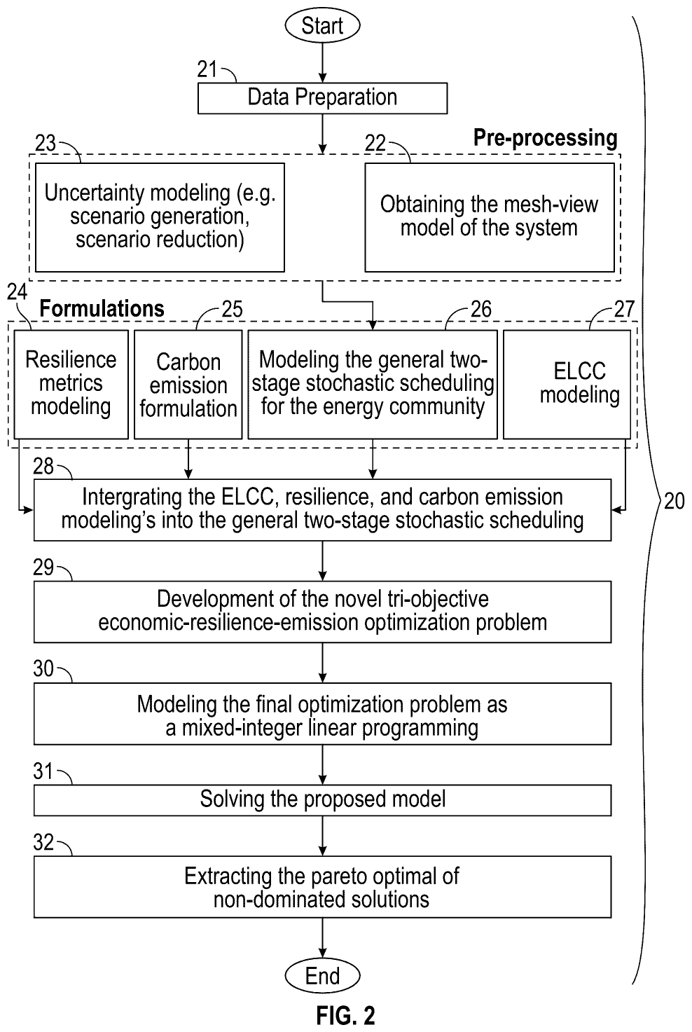

FIG. 2 is a flowchart for a method 20 for implementing the framework disclosed herein. Block 21 calls for data preparation which entails receiving the necessary data. Non-limiting embodiments of the data include output from grid electrical components, including their function and location, connections to lines and other components, and environmental parameters for operation (e.g., acceptable temperature values, humidity values, acceleration values, wind speed values). The data may also include expected (day ahead) and actual (currently happening) weather parameters such as temperature, rain amounts, wind speed and direction, and storm trajectory. Non-limiting embodiments of the grid electrical components include transmission and distribution wires, cables and lines and their supports such as poles and towers, transformers, switchgear, generation facilities and type and capacity, and energy storage facilities and type and capacity. Data preparation may also involve formatting the input data into a selected structure suitable for processing.

Block 22 calls for obtaining a mesh-view model of the electric grid of interest. This block may include plotting the grid electrical components on a map of the area of the grid and overlaying grid lines onto the map. This process is referred to as “mesh-view grid mapping.” In general, the spacing of the grid lines is small enough to illustrate an individual component separately from other components that are not directly near the individual component. The mesh-view grid mapping technique entails segmenting the EC or electric grid into numerous finely structured two-dimensional grid cells. Each grid cell, defined by a distinct pair of coordinates, represents a specific geographical area within the community. This granular representation is pivotal in accurately modeling and managing the spatial aspects of the EC. This technique enhances analysis of extreme events, such as storms, floods, earthquakes, or other natural disasters. By superimposing the influence of an event onto the mesh-view map, the method allows for a prediction and assessment of the impacts on the grid. The method facilitates identification of which areas and grid components are likely to be affected by an event, enabling operators by providing information for implementation of preemptive measures and swift response strategies.

The methodology behind this mapping technique encompasses several steps. Examples of which are discussed below:
Data Collection and Analysis: Gathering comprehensive geographical and infrastructural data of the EC is includes as part of this method. This data includes information about the locations of power lines, transformers, generation units, storage facilities, and critical load points.
Grid Segmentation: The entire geographical area of the EC is segmented into a grid of cells. The size and number of cells are determined based on the level of detail required and the scale of the EC. The level of detail required is generally sufficient to correlate a location of each component with a predicted or actual grid disturbance event, allowing for the determination of potential impact for each component.
Component Allocation: Each grid component, such as distribution and transmission lines, transformers, switchgear, DERs, and load centers, is allocated to specific cells based on their geographical coordinates.
Event Characterization: Characteristics of potential extreme events, including their size, intensity, trajectory, and duration, are integrated into the model. This information is used to simulate the path of the extreme event (or grid disturbance event) and its impact across the mesh-view grid map.
Impact Assessment: By overlaying the event characteristics onto the mesh-view grid map, the method assesses the potential impact on various grid components. This includes determining which cells (and thereby which components) fall within the event's impact zone of the extreme event. By knowing the operational specifications of each grid component, their exact locations on the mesh-view grid map, and the parameters of the extreme event at the location of each grid component, the likelihood of survival of each component can be determined. For example, if a grid component is specified to be operational up to a wind speed of X and the wind speed due to the extreme event is expected to exceed X at the location of the grid component, then the grid component is not expected to survive and may be expected to be out of service due to the extreme event. Alternatively or in addition, a recorded history of extreme events and associated parameters and their effect on grid components may be used as an indication as to the likelihood of survival of the grid components.
Resilience Planning: Based on the impact assessment, strategies for enhancing grid resilience are devised. This may involve reconfiguring the grid, activating DERs in unaffected areas, or rerouting power to maintain supply in regions expected to lose power or actually losing power.
Continuous Improvement and Updating: The mesh-view map is dynamically updated with new data and insights, ensuring that it reflects the latest developments and can effectively guide resilience enhancement strategies.

The mesh-view grid mapping technique is an advancement in the field of EC management, particularly in the context of resilience against extreme events. Its introduction improves how energy communities anticipate and react to environmental challenges. This method includes fine-grained analysis and visualization capabilities for grid management, providing system precision and adaptability. The technique not only facilitates improved accuracy in identifying vulnerable grid segments but also improves resilience planning by enabling tailored strategies that are both efficient and effective.

Furthermore, the dynamic nature of mesh-view grid mapping allows it to evolve in infrastructural developments and shifting risk landscapes. This helps to ensure that ECs are always equipped with the most current and relevant data for decision-making. The comprehensive visual representation provided by this technique is not only a tool for technical analysis but also serves as a medium for communicating complex grid dynamics to a range of stakeholders, from engineers to policymakers. This aspect of the technique enhances collaborative efforts and ensures that resilience strategies are bases in a shared understanding of the challenges and solutions.

In summary, the Mesh-view Grid Mapping technique is a new approach to enhancing situational awareness in power systems, particularly during extreme weather events. It divides the entire power grid into smaller, manageable cells, forming a “mesh” that enables detailed monitoring and analysis. Each cell represents a specific geographical segment of the grid, containing critical components such as distribution lines, transformers, substations, and DERs. The notable features and functions include: (1) Real-time data adaptation—The technique integrates data from diverse sources, including sensors, smart meters, SCADA systems, weather forecasts, and outage management systems. This approach implements a real-time data fusion model, combining geographical information systems (GIS) with time-synchronized phasor measurement units (PMUs) to dynamically adjust to changing grid conditions. As disclosed herein, in the use of adaptive algorithms that predict event trajectories based on historical weather data and real-time sensor inputs enables proactive grid management rather than reactive responses. (2) Enhanced situational awareness—By segmenting the grid into discrete cells, the mapping utilizes a dynamic clustering algorithm to group nearby critical components (such as feeders, transformers, and substations) that share similar risk profiles. This clustering facilitates rapid identification of high-risk zones, allowing operators to pre-emptively isolate faults, reroute power, and deploy restoration resources. As disclosed herein, the use of multi-layer data visualization that overlays operational data with risk factors improves the decision-making process. (3) Critical component identification—The mapping uses machine learning models to identify and rank critical components within each cell based on their importance to grid stability and their vulnerability to different weather events. As disclosed herein, a predictive risk assessment model is used that quantifies the probability of failure for each component, considering factors such as age, maintenance history, and exposure to extreme weather. This detailed risk assessment aids in developing an intelligent priority-based restoration strategy during outages. (4) Impact quantification: Each cell's mapping evaluates potential event impacts by employing a probabilistic load-flow analysis, which calculates the likelihood of equipment failure, power outages, or load shedding requirements under different scenarios. As disclosed herein, the integration of Monte Carlo simulations, allowing for a comprehensive risk assessment that can simulate thousands of event scenarios, provides electric utilities with a more accurate understanding of potential grid disruptions. (5) Support for planning and operations: The mesh-view technique supports utilities in real-time grid reconfiguration by employing a network optimization model that identifies optimal DER placements and switching actions to maintain grid reliability. This approach includes a sensitivity analysis to determine the most effective DER integration strategies and asset-hardening measures, providing utilities with both short-term operational flexibility and long-term resilience planning.

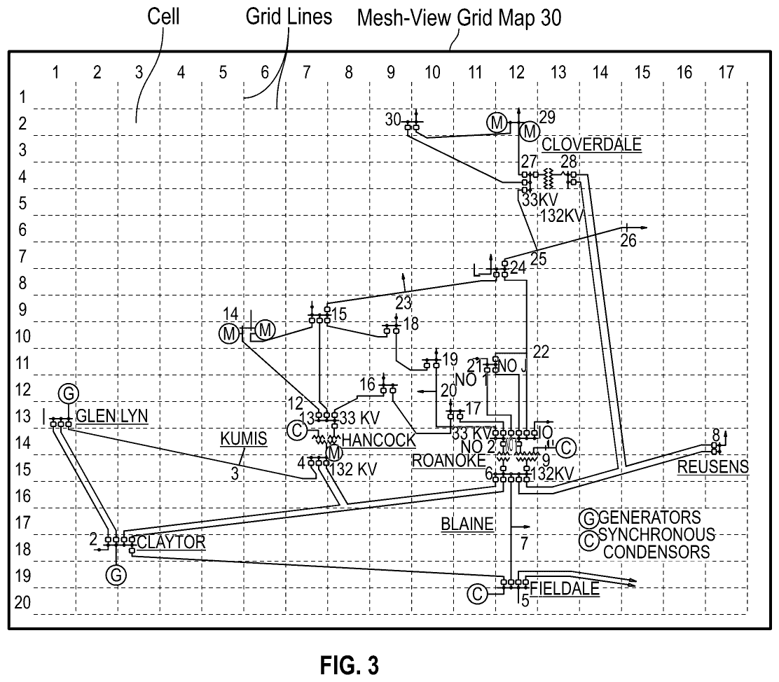

FIG. 3 illustrates an example of a mesh-view grid map 30 and in particular a mesh-view of the IEEE 30-bus test system. The circles represent grid electrical components and the lines represent transmission or distribution lines. In this figure, it is assumed that the surface of the power system can be divided into 20×17=340 equal cells. Each cell has two components (i.e., row and column) and are used to locate the event and equipment. When a disturbance event occurs in a cell, the central areas and margins of the event are extracted accordingly to the corresponding type of the event. For example, if an event happens in cell (12, 7) (12th row, 7^{th} column), the lines between buses 14 and 12, and buses 15 to 12 are then tripped out.

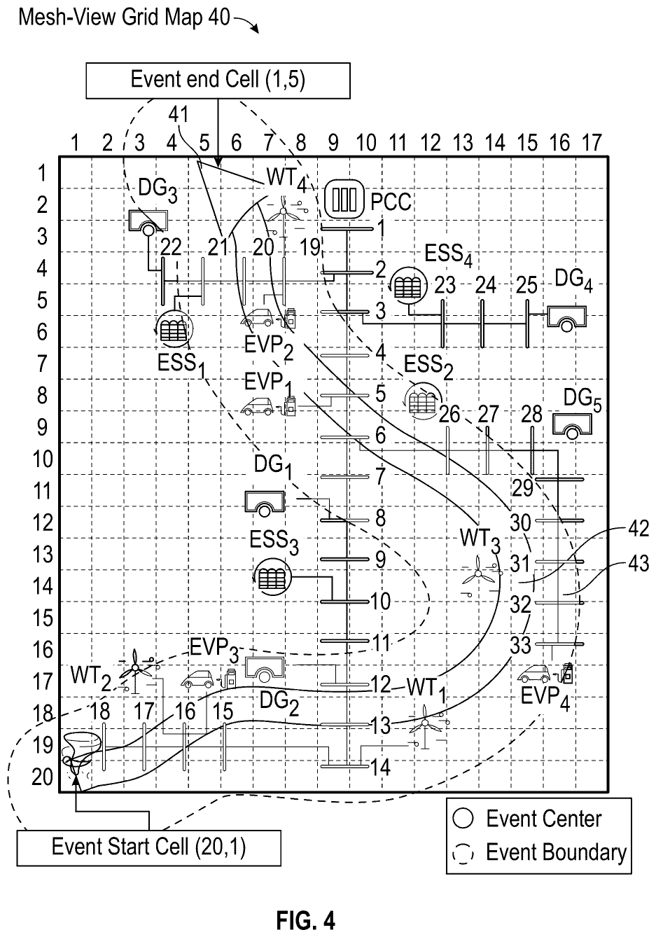

FIG. 4 illustrates an example of a mesh-view grid map 40 having plotted on it a path 41 of a disturbance event or storm as it moves through the electric grid. A center region 42 of the path represents the center of the event and a side region 43 to both sides of the center region represent a boundary of the event where the intensity of the event along the boundary is less than the intensity at the center. In FIG. 4, the numbers on the perimeter of the mesh-view grid map 40 are cell identification numbers. Vertical or horizontal straight lines numbered 1-33 within the mesh-view grid map 40 are electrical busses. In FIG. 4, DG refers to distributed generation, WT refers to wind turbine, ESS refers to energy storage system, and EVP refers to electric vehicle parking.

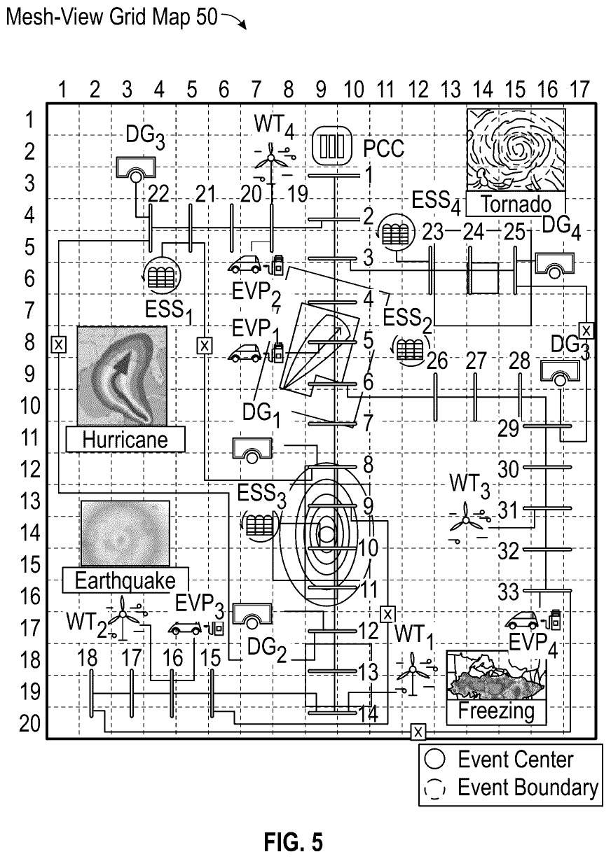

FIG. 5 illustrates an example of a mesh-view grid map 50 having plotted on it various disturbance events. The disturbance events include a hurricane, an earthquake, a tornado or super storm, and sub-freezing temperatures. In FIG. 5, the numbers on the perimeter of the mesh-view grid map 50 are cell identification numbers. Vertical or horizontal straight lines numbered 1-33 within the mesh-view grid map 50 are electrical busses. In FIG. 5, DG refers to distributed generation, WT refers to wind turbine, ESS refers to energy storage system, and EVP refers to electric vehicle parking.

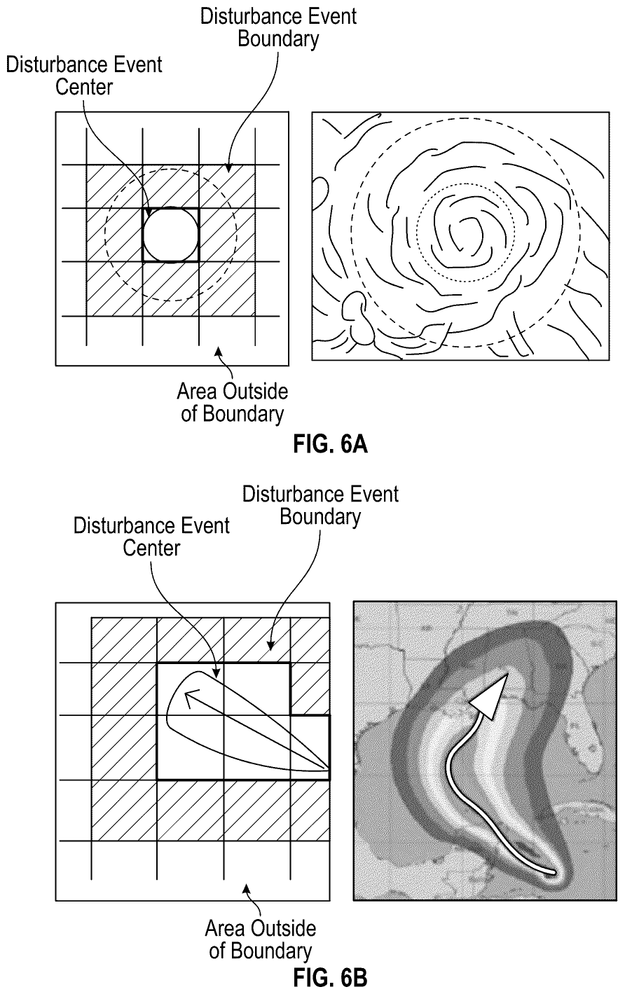

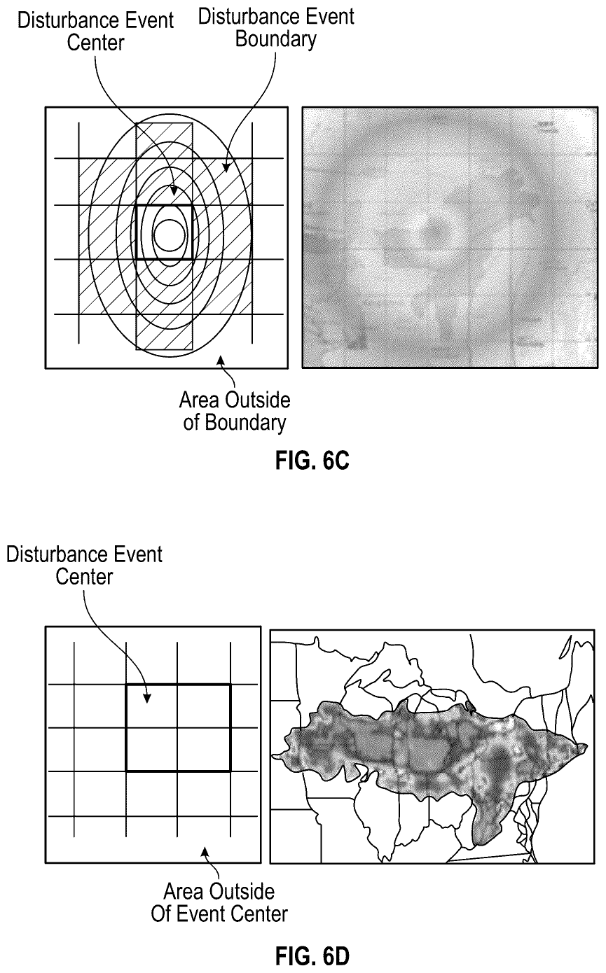

FIG. 6 illustrates how various disturbance events are plotted onto cells of the mesh-view grid map. Specifically, FIG. 6A illustrates the plotting of a tornado or super storm, FIG. 6B illustrates the plotting of a hurricane, FIG. 6C illustrates the plotting of an earthquake, and FIG. 6D illustrates the plotting of sub-freezing temperatures. In the Figures, the center area of the event depicts an intensity higher than the intensity at the boundary. With respect to super storms, storms typically occur in one area and are accompanied with heavy rainfall. According to the geographical maps of the storm, the corresponding model on the mesh view of the power system is shown in FIG. 6A. As shown in FIG. 6A, the center area of the storm indicates a high probability of equipment outage in this area. In other words, any equipment located in this cell is very likely to fail. Hashed areas indicate a boundary are the frontier of the event where equipment is less likely to fail but may still have a realistic probability of failure. The areas outside of the boundary are the safe areas of the power system where the probability of equipment outage is very low. Therefore, the stochastic parameters related to the storm represent the probability of the occurrence, the location on the mesh view cells of the power system, and the storm intensity (e.g. wind speed and rain amount). The stochastic model for the hurricane illustrated in FIG. 6B includes the parameters of probability of occurrence, location, direction of motion, and the hurricane intensity (e.g. wind speed and rain amount). Regarding the earthquake illustrated in FIG. 6C, an earthquake is a natural event that occurs in the deep of the earth. Strong shocks of the earthquake can cause serious damage to human infrastructure, especially when it comes to the power system. According to the existing models for earthquake behavior, the model is shown on the mesh view of the power system in the form of concentric ellipses, the higher the distance from the center, the lower its intensity is. Similarly, the stochastic parameters of the earthquake are the probability of its occurrence, location and severity level (e.g., acceleration levels as a function of distance from the center of the earthquake). With respect to sub-freezing temperatures or ice-freezing illustrated in the mesh-view of FIG. 6D, based on the geographical maps, it is assumed that the ice freezing is occurring in an area of the power system (that may contain some cells) with no border areas. Therefore, it is only the center of the event that experiences the emergency condition while the other parts remain to be safe.

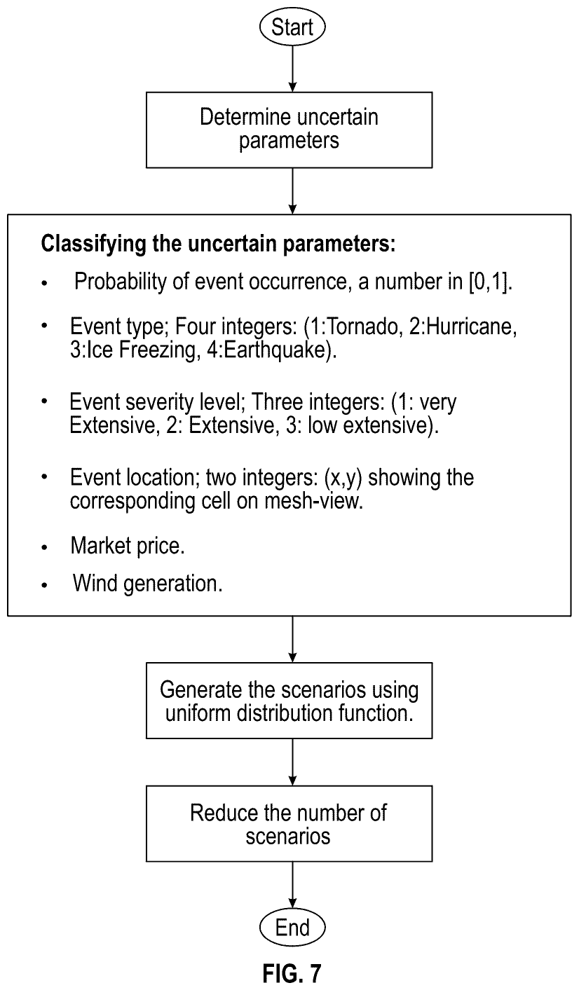

Referring back to FIG. 2, block 23 calls for uncertainty modelling related to generation of various scenarios. In this block, a variety of possible future states for the electric grid are generated, accounting for uncertainties such as renewable energy variability, demand fluctuations, market price volatility, and extreme weather events. The goal is to provide multiple representative scenarios that capture the stochastic nature of the grid and energy environment. FIG. 7 illustrates a flowchart for a workflow 70 for implementing block 23. Block 71 calls for determining uncertain parameters that have an uncertainty associated with those parameters. Block 72 calls classifying the uncertain parameters. In one or more embodiments, the uncertain parameters include probability of disturbance event occurrence, type of disturbance event, severity level of the disturbance event, location of the disturbance event, market price, and wind generation availability. Classifying relates to assigning a number to the parameters so that the parameters can be varied for analysis. Block 73 calls for generating scenarios. In one or more embodiments, generating scenarios involves using Monte Carlo simulations or scenario tree generation to create possible future states based on historical data and known uncertainties. In one or more embodiments, the scenarios are generated using a uniform distribution function. That is, the probabilities of the uncertain parameters are varied uniformly to generate scenarios resulting from a disturbance event. In one or more embodiments, the number of generated scenarios is in the thousands such as five thousand for example. Each scenario provides an outcome affecting the electric grid. Block 74 calls for reducing the number of scenarios. The number of scenarios is reduced, such as to ten for example, to alleviate the computational burden of performing simulations. In one or more embodiments, the number of scenarios is reduced by clustering similar scenarios, selecting representative scenarios using algorithms such as backward reduction, or using the K-mean clustering method. The output from this block is a set of distinct scenarios that capture the variability in energy generation, demand, and grid conditions. The final selected scenarios are then used along with the mesh-view map in blocks 24, 25, 26, and 27 in FIG. 2.

Block 24 calls for resilience metrics modeling. This block evaluates how resilient the grid is under each generated scenario. The primary goal is to quantify resilience in terms of the grid's resilience to maintain service during disruptions (e.g., extreme weather events). The resilience of power systems against high-impact-low-probability (HILP) events is defined as the ability to withstand and fast recovery. Loss of Load Probability (LOLP) is the likelihood that the electric grid will not meet load demand in a given scenario and is defined as below. Loss of Load Expectation (LOLE) is the expected number of hours or days during which load demand will not be met and is defined as below.

$$LOLP = \frac{\sum Unsupplied Load}{Total Load Demand}$$

$$LOLE = LOLP \times Time Period ( e . g . , in hours or days )$$

Four important resilience criteria are considered to evaluate the electric grid in the face of a catastrophic event. From the technical aspect, the loss of load probability (LOLP) and expected demand not supplied (EDNS) can be used. These parameters measure the quality of the power system during the event. Consumer satisfaction with the network that depends on the amount of fed loads, is also taken into account in these metrics. The LOLP and EDNS metrics are given in equations (1), (2) and (3), respectively.

$$LOLP = \frac{1}{{N}_{s}} {\sum }_{s = 1}^{{N}_{s}} {χ}_{s} \times {P}_{s} \qquad ( 1 )$$

$$EDNS = \frac{1}{{N}_{s}} {\sum }_{s = 1}^{{N}_{S}} {χ}_{s} \times {P}_{s} \times {Ω}_{s} \qquad ( 2 )$$

$${χ}_{s} = \{ \begin{matrix}0 if {c}_{s} - {d}_{s} \geq 0 \\ 1 if {c}_{s} - {d}_{s} < 0\end{matrix} \qquad ( 3 )$$

where Nₛ is the number of scenarios (preferably several), χₛ is a binary variable that indicates whether the load of the system exceeds the total generation capacity (equal to 1 or not equal to 0), ds is the total load of the system in scenario s, cₛ is total generation capacity of the system in
scenario s, Ps is the probability of event occurrence in scenario s, s is the index of scenarios, and Ωs it the amount of the load curtailment in scenario s, which is achieved by optimal power flow (OPF) calculation.

To evaluate the ability of the power system to withstand against HILP event, a fragility function criteria is employed and calculated based on the number of lines on outage during the event with the expression shown as follows in equation (4):

$$ϒ = \frac{1}{{N}_{s}} {\sum }_{s = 1}^{{N}_{s}} {\int }_{0}^{∞} {k}_{s} {f}_{s} ( k ) dk \qquad ( 4 )$$

where kₛ is the number of lines on outage in scenario s, ƒₛ is a fragility function in scenario s, and Υ is the expected number of lines on outage.

It is evident to see that, the process of power system restoration after a catastrophic event also depends on the extent of damage to other human infrastructures, such as transportation, communication systems, cyber infrastructures, and material resources. Moreover, the type and severity level of the extreme event are also effective in this criteria. With the above, the disclosed restoration index is then presented in equations (5) and (6).

$$Ψ = \frac{1}{{N}_{s}} {\sum }_{s = 1}^{{N}_{s}} {\sum }_{i = 1}^{5} {ω}_{i} {ε}_{i} {P}_{s} \times {P}_{s}^{char} \qquad ( 5 )$$

$${\sum }_{i = 1}^{5} {ω}_{i} = 1 \qquad ( 6 )$$

where ωᵢ is the weight coefficient, εᵢ is the value of restoration factor on the i-th network, i is the index of grid restoration factors, Pₛ^{char} is the probability of event characteristics, and Ψ is the grid restoration metric.

Other resilience metrics may also be used as follows.
Fragility Index (FI): This metric assesses the grid's vulnerability to extreme events. It is calculated based on the percentage decrease in system performance during an event. A lower FI indicates a more robust and less vulnerable system.
Restoration Index (RI): RI measures the efficiency and speed of the grid's recovery process after an event. It evaluates how quickly the system can restore services to its normal operating condition. A higher RI reflects a quicker and more effective restoration capability.
Voltage Deviation Index (VDI): VDI quantifies the stability of voltage levels across the grid during normal and emergency operations. It highlights areas with significant voltage fluctuations, guiding efforts to stabilize voltage profiles for improved reliability.
Lost Energy Index (LEI): LEI measures the amount of energy that cannot be supplied due to grid disruptions. It is a metric for understanding the impact of outages on overall energy delivery and customer service.

The process of integrating these resilience metrics into the grid optimization framework is methodically structured using the following features.
Algorithmic Inclusion: Each resilience metric is algorithmically embedded within the management system of the electric grid. This inclusion ensures that resilience considerations are factored into every operational decision, from load balancing to emergency response strategies.
Optimization Model Adaptation: The optimization model of the electric grid is adapted to include these metrics as part of its objective function or as constraints. This adaptation allows the system to simultaneously optimize operational efficiency, cost-effectiveness, and resilience.
Real-Time Assessment and Adjustment: The system continuously monitors and assesses these resilience metrics in real-time. Based on this assessment, it dynamically adjusts operational strategies to enhance resilience. For instance, in response to a high FI, the system may reroute power or activate contingency measures.
Feedback Loop for Improvement: The integration process includes a feedback mechanism where outcomes are analyzed to identify areas for improvement. This continuous learning approach ensures ongoing enhancement of grid resilience.

Block 25 calls for carbon emission formulation. This block calculates the carbon emissions associated with each scenario by evaluating the energy mix used to meet demand. It considers both renewable and non-renewable sources, assigning emission factors to each. The carbon emission formulation encompasses assigning an amount of carbon emission over time for each energy resource where the energy resource provided a known amount of power (e.g., energy supplied per time period). The energy resource may be a distributed energy resource or an energy resource located outside of the electric grid that exports power into the electric grid. Thus, a total amount of carbon emitted for a certain period of time from each energy resource can be determined by knowing the amount of time each energy resource supplies power or the total amount of power supplied by each energy resource. For each scenario, carbon emissions are calculated based on the energy generation mix. Emission factors for fossil fuel sources (e.g., coal, natural gas) are applied to determine the total carbon emissions.

$$Carbon Emissions = \sum ( Energy Output from Source \times Emission Factor of Source )$$

Block 26 calls for modeling general two-stage stochastic scheduling for the energy community (TSERS). This block performs a two-stage optimization, where the first stage handles day-ahead planning and the second stage addresses real-time operations. The uncertainty from the scenarios (generated in the Uncertainty Modeling block) is used to create a flexible and adaptive schedule that can handle variations in supply, demand, and extreme events. The term “schedule” relates to energy resources selected to supply electricity to the electric grid and the amount of power to be supplied by each energy resource. For Day-Ahead Planning, the grid operator sets an operational plan based on predicted demand and generation. The plan includes scheduling of DERs and other resources. For Real-Time Adjustments, as real-time data becomes available, the grid operator makes adjustments to the day-ahead schedule based on actual conditions. The generalized TSERS consists of two stages, which are referred to as either here-and-now (H&N) and wait-and-see (W&S) or day-ahead (DA) and real-time (RT). For consistency, the first stage is denoted as H&N, and the second stage as W&S. Furthermore, uppercase and lowercase letters are utilized to represent variables in H&N and W&S, respectively. For an economic objective function, let X_{H&N} and x_{w&s} be the corresponding vectors of decision variables representing each stage. The cost under the economic objective function (i.e., ƒ₁) associated with both H&N and W&S variables is presented in equation (8) follows:

$${f}_{1} = {\sum }_{t = {t}_{0}}^{{N}_{t}} {C}_{t} ( {X}_{H \& N} , {x}_{w \& S} ) = {\sum }_{t = {t}_{0}}^{{N}_{t}} ( {C}_{t}^{H \& N} + {c}_{t}^{W \& S} ) \qquad ( 8 )$$

Here, t is a time index (e.g., hours) and (and c are costs. Cₜ^{H&N} is calculated hourly and encompasses the cost of exchange with the upstream network, the cost of demand-side reserves, and the income generated from selling energy to customers.
Similarly, cₜ^{W&S} is calculated hourly in each scenario and is presented in equation (9). It encompasses the cost of power exchange with the upstream network (cᵤ), the cost of purchasing energy from independent DERs, the operational cost of supplying energy from dependent DERs, and the costs associated with demand-side reserves (c_{d}).

$${c}_{t}^{W \& S} = {c}_{t}^{u} + {c}_{t}^{d} \qquad ( 9 )$$

where the term cₜ^{u} represents the cost of adjustments in the day-ahead scheduled import/export power based on the real-time market prices and cₜ^{d} represents the cost of purchasing energy from DERs and demand-side reserves. The result of this block is an optimized operational schedule for each scenario. This schedule ensures that the grid can handle uncertainties while minimizing costs and maximizing resilience. The schedule is then passed to the Integration Block, where it is combined with resilience, ELCC, and emission data for final optimization.

Block 27 calls for effective load-carrying capability (ELCC) modelling. The ELCC modeling block quantifies how much additional load DERs can support reliably under each scenario. ELCC provides a measure of the resilience contribution of DERs, especially under conditions of peak demand or extreme weather. The output of DERs (e.g., solar PV, wind turbines, batteries) is modeled based on scenario data. ELCC is then calculated by comparing the system's reliability with and without DER integration. A DER-Based ELCC quantification method is a transformative approach designed to assess the capacity contribution of DERs in supporting and enhancing the resilience of the grid, especially during emergency situations. This method is involved in the context of energy systems increasingly reliant on renewable energy sources and DERs. The ELCC metric quantifies the additional load that DERs can reliably support, thereby providing a robust measure of the DER contribution to grid resilience. ELCC may be quantified as presented in equation (10):

$$ELCC = ( \frac{Load with DERs - Load without DERs}{Total Load} ) \times 100 \% . \qquad ( 10 )$$

Some aspects of the ELCC quantification method include:
ELCC as a Resilience Metric: ELCC is employed as a resilience metric, evaluating the ability of DERs to sustain additional load during grid stress or failure events, thereby enhancing the grid's overall resilience;
Reliability Metrics Integration: The ELCC quantification is based on reliability metrics such as Loss of Load Probability (LOLP) and Loss of Load Expectation (LOLE). These metrics are pivotal in estimating the reliability and robustness of the power system under varying operational conditions;
LOLP and LOLE Formulations: The ELCC quantification utilizes LOLP and LOLE in its calculation process. LOLP is a probabilistic measure indicating the likelihood of a power system's inability to meet load demand at a given time. LOLE extends this concept, quantifying the expected duration within which the system fails to meet the load demand. The formulations for LOLP and LOLE in the “Here-and-Now” (H&N) and “Wait-and-See” (W&S) stages are given in equations (11), (12), and (13):

$${LOLP}^{H \& N} = \frac{1}{{N}_{t}} {\sum }_{t = {t}_{0}}^{{N}_{t}} {ζ}_{t} \qquad ( 11 )$$

For H&N Stage:
For W&S Stage:

$${lolp}^{W \& S} = \frac{1}{{N}_{Γ}} {\sum }_{ω = 1}^{{N}_{Γ}} {v}_{ω} {P}_{e , ω} \frac{1}{{N}_{t}} {\sum }_{t = {t}_{0}}^{{N}_{t}} {ζ}_{t ω} \qquad ( 12 )$$

LOLE is calculated as LOLE^{H&N}=LOLP^{H&N}×24×60 (13)
and similarly for the W&S stage.
   Here, t is the time index, ω is the scenario index, P_{e·ω} is the probability of event occurrence, and ζ is a binary variable and is 1 if at the subscript index the lost load becomes greater than zero (otherwise, it is 0).
ELCC Calculation Based on Reliability Metrics: The ELCC for DERs is then calculated using these reliability metrics, particularly focusing on the LOLE metric. The ELCC essentially quantifies the additional load capacity that can be reliably supported by integrating DERs into the grid. The calculation formula for ELCC is given by equation (14):

$${ELCC}_{\%}^{DER} = ( \frac{{L}_{2} - {L}_{1}}{{Load}_{total}} ) \times 100. \qquad ( 14 )$$

Here, L₁ and L₂ represent the load levels before and after integrating the DERs.
Enhancement in Grid Resilience: By quantifying the additional load support capacity of DERs, the ELCC metric provides a clear and measurable understanding of how DER integration contributes to grid resilience, especially in the face of extreme events or operational stress.
Application in Grid Planning and Operation: The quantification method aids in strategic grid planning and operational decision-making, offering insights into the optimal placement and utilization of DERs for maximum resilience benefit.

The ELCC results provide a measure of the reliability and resilience boost provided by DERs. These results are passed to an Integration Block, where they are used to determine the best grid operation strategy that balances resilience, costs, and emissions.

Block 28 calls for integrating ELCC, resilience, and carbon emission quantifications into the general two-stage stochastic scheduling. In this block, the results from the previous blocks (Resilience Metrics, Carbon Emission, Two-Stage Scheduling, and ELCC) are integrated into a unified model. This model is used to create a comprehensive grid management strategy that balances resilience, emissions, and operational costs. The integration is done using a multi-objective optimization framework, which simultaneously balances cost-efficiency, grid resilience, and carbon emissions across all scenarios.

The optimization framework is designed to integrate and balance multiple objectives, namely operational cost, grid resilience, and carbon emissions. This holistic approach also enables the energy community to optimize grid performance while addressing environmental concerns and ensuring robustness against extreme events. The framework effectively models the interdependencies and trade-offs between these objectives, providing a comprehensive tool for strategic decision-making in grid management.

The optimization framework integrates stochastic variables to reflect real-world conditions and uncertainties. Aspects of variables in the optimization framework include:
Market Prices: Reflecting the variability of energy costs over time, influenced by supply-demand dynamics, policy changes, and other market factors; and
Renewable Energy Output: Capturing the inherent unpredictability of wind, solar, and other renewable energy sources due to weather conditions and environmental factors.
   These stochastic elements are modeled using probabilistic methods or scenario-based approaches, enhancing the realism and applicability of the optimization results.

A core of the optimization framework lies in its ability to find an optimal balance between competing objectives through multi-objective optimization techniques. Some of these techniques are as follows.
Economic Objective: The economic objective function minimizes the total operational cost over the scheduling horizon. It includes the costs of energy generation, purchase, and operational expenditures of the EC's components. The formulation is given in equation (15) as:

$$min {f}_{1} = {\sum }_{t = 1}^{T} ( {C}_{gen , t} + {C}_{buy , t} + {C}_{opex , t} ) \qquad ( 15 )$$

where t is the time index number, C_{gen,t} is the cost of generation at t, C_{buy,t} is the cost of buying power at t, and C_{opex,t} is the operating expense at t.
Resilience Objective: This objective focuses on improving the grid's ability to withstand and recover from disruptions, particularly during extreme events. The resilience metric may include components like system stability, reliability, and recovery speed. The formulation can be as an example in equation (16):

$$min {f}_{2} = {\sum }_{t = 1}^{T} ( {R}_{stability , t} + {R}_{reliability , t} + {R}_{recovery , t} ) . \qquad ( 16 )$$

Carbon Emission Objective: This objective aims to minimize carbon emissions from grid operations, thereby supporting sustainability goals. It involves reducing emissions from conventional generation sources and increasing the integration of renewable resources. The formulation is given in equation (17):

$$min {f}_{3} = {\sum }_{t = 1}^{T} {E}_{CO 2 , t} \qquad ( 17 )$$

where E_{CO2,t} is the emissions of CO2 at time period t and T is the total number of time periods.

Block 28 includes several features, which are discussed as follows. (1) Dynamic balancing of objectives: The framework uses a multi-objective optimization model that dynamically adjusts the weighting of operational costs, grid resilience, and carbon emissions in response to real-time grid conditions. The innovative aspect is the integration of a reinforcement learning-based decision support system, which continuously learns from historical grid performance and adjusts operational strategies to balance these objectives more effectively. (2) Incorporating Uncertainties: The framework employs stochastic programming that models uncertainties in renewable generation, market prices, and event characteristics. One of the innovations is the use of scenario-tree generation algorithms, which break down uncertainties into multiple stages, allowing for more accurate modeling of possible future states. This stochastic approach improves the robustness of decision-making under varying conditions. (3) Multi-stage Optimization: This method applies a hierarchical optimization structure, optimizing electric grid operations at multiple levels (e.g., day-ahead, intra-day, and real-time). Another of the innovations is the introduction of a rolling-horizon optimization process, where strategies are continuously updated based on the latest weather forecasts, grid status, and market prices, ensuring that the electric grid maintains resilience while adapting to changing conditions. (4) Resilience-Focused Scheduling: The scheduling framework incorporates risk-adjusted resilience metrics into the optimization model, ensuring critical loads are prioritized during emergencies. As disclosed herein, the use of adaptive risk management, which dynamically allocates resources based on real-time risk assessments, provides the electric grid with sufficient flexibility to handle unexpected disruptions and faults. (5) Carbon Emission Management: By including carbon emissions as an objective, the framework introduces a carbon budget constraint, which limits the total allowable emissions over a specified period. as disclosed herein, a penalty factor mechanism, which incentivizes the dispatch of renewable energy sources and battery storage, directly contributes to a more sustainable grid operation. (6) Operational Cost Reduction: The framework incorporates a cost-benefit analysis module, which evaluates the economic and resilience impacts of each operational decision. As disclosed herein, the use of a multi-criteria decision analysis dynamically optimizes resource dispatch, managing reserve margins and mitigating risks associated with extreme events while minimizing overall costs.

Block 29 calls for developing a tri-objective economic, resilience, and carbon emission optimization problem. Here, the framework balances competing priorities to develop an optimized strategy for electric grid management. This block performs the final optimization to balance economic costs, grid resilience, and carbon emissions using a tri-objective optimization framework. This ensures that the grid is operated in a cost-effective manner while enhancing its ability to withstand disruptions and minimizing its environmental impact. A methodology for implementing this block includes modeling the three objectives (economic, resilience, and carbon emission reduction) as separate objective functions, with the goal of finding an optimal trade-off between them. The results are obtained by solving a multi-objective optimization problem, which can be generalized as min (ƒ₁(cost), ƒ₂(resilience), ƒ₃(emissions)). The optimized solution is used to reconfigure the grid based on the best trade-offs identified for resilience, cost, and carbon emissions.

Block 30 calls for modelling the tri-objective economic, resilience, and carbon emission optimization problem as a mixed-integer-linear-program. This block takes the results from the tri-objective optimization formulation block and formulates the problem as a mixed-integer-linear-program (MILP). The MILP framework is used because of its ability to handle both binary decisions (e.g., switching resources on/off) and continuous variables (e.g., how much power to generate). The MILP formulation defines the final optimization problem, which is then solved to generate specific actions for grid management.

Block 31 calls for solving the mixed-integer-linear-program. In one or more embodiments, an advanced solver is used to determine the optimal configuration for the operations of the electric grid. The solver computes the best set of actions to take based on the integrated data from the previous blocks.

Block 32 calls for extracting Pareto Optimal solutions. This block identifies the Pareto-optimal solutions from the results generated by the solver in the previous block. Pareto optimality refers to solutions where no objective (e.g., cost, resilience, carbon emissions) can be improved without worsening at least one other objective.

It can be appreciated that a Pareto Optimal solution or solutions may be implemented in an implementation phase following block 32. Non-limiting embodiments of implementation may include reconfigured a transmission or distribution network or controlling an energy source supplying power to the electric grid such as by activating (i.e., turning on or connecting to the grid) or deactivating (i.e., turning off or disconnecting from the grid) that energy source. The reconfiguring or controlling may be performed manually or automatically. Automatic reconfiguration or control may be performed using remote-controlled switchgear or actuators as appropriate. A control signal for controlling the automatic dynamic reconfiguration or control of an energy resource may be provided by the controller 14. Alternatively or in addition to the control signal, the controller 14 may provide an information signal to an operator to initiate manual control.

Dynamic grid reconfiguration and control are components of the computer processing system 10 and the framework implemented by it, which is designed to enhance grid resilience and adaptability. It involves the strategic adjustment of grid topology in response to various operational scenarios and emergency conditions. This process utilizes intelligent switching mechanisms and advanced control strategies to restructure the network configuration, thereby optimizing power flow distribution and minimizing potential disruptions.

The reconfiguration and control are facilitated through the implementation of advanced algorithms capable of analyzing real-time data, including load demands, generation capacities, and network conditions. By selectively activating or deactivating certain lines or components, the grid can efficiently manage and redistribute electrical loads. This not only improves overall system reliability but also ensures a more efficient utilization of available resources, especially during peak demand periods or in the aftermath of unforeseen incidents like extreme weather events.

Trigger conditions for dynamic grid reconfiguration and control are multifaceted and are determined based on a range of operational and emergency scenarios. Some of these scenarios are discussed as follows.
Line Failures or Faults: In the event of line outages or faults, the system automatically initiates reconfiguration to reroute power through alternative pathways, thereby ensuring continuous supply and minimizing service disruptions.
Surge in Demand: Sudden spikes in electricity demand can strain the grid. Reconfiguration in such scenarios helps in balancing the load by redistributing power from surplus areas to those experiencing higher demand.
Integration of Renewable Energy Sources: Fluctuations in power generation from renewable sources like solar or wind due to environmental variability necessitate real-time grid adjustments to maintain stability and optimal operation.
Emergency Conditions: Extreme events such as storms, earthquakes, or other disasters may damage grid infrastructure. Reconfiguration in these scenarios is crucial for quick restoration and maintaining power supply to critical loads.

The process of integrating these resilience metrics into the grid optimization framework is methodically structured as discussed below.
Algorithmic Inclusion: Each resilience metric is algorithmically embedded within the grid management system. This inclusion ensures that resilience considerations are factored into every operational decision, from load balancing to emergency response strategies.
Optimization Model Adaptation: The optimization model of the grid management system is adapted to include these metrics as part of its objective function or as constraints. This adaptation allows the system to simultaneously optimize operational efficiency, cost-effectiveness, and resilience.
Real-Time Assessment and Adjustment: The grid management system continuously monitors and assesses these resilience metrics in real-time. Based on this assessment, it dynamically adjusts operational strategies to enhance resilience. For instance, in response to a high fragility index value, the grid management system may reroute power along a less fragile path or activate contingency measures.
Feedback Loop for Improvement: The integration process includes a feedback mechanism where outcomes are analyzed to identify areas for improvement. Feedback may be provided by the sensor 9, which can be configured to sense environment parameters, electric grid component parameters, or electric grid operational parameters as non-limiting examples. This continuous learning approach ensures ongoing enhancement of grid resilience.

The implementation of this grid management system, focusing on the integration of DERs for enhanced grid resilience requires both hardware and software components as discussed below.
Hardware Requirements: The grid management system generally requires a range of smart grid technologies, including intelligent sensors, automated control systems, and advanced metering infrastructure. DERs such as solar panels, wind turbines, energy storage systems, and backup generators are also generally required to provide diverse energy resource options.
Software Requirements: Software elements include a platform for data analytics, optimization, and control. This platform is needed to efficiently process data from diverse sources, including grid performance, consumer demand, and weather forecasts. It needs to also support stochastic scheduling, multi-objective optimization, and resilience metric computation.

The effectiveness, adaptability, and efficiency of the disclosure is demonstrated in various scenarios such as natural disasters, peak demand management, and integration with renewable energy sources. For natural disasters such as hurricanes, the system of the disclosure effectively manages DERs, dynamically reconfigures the grid, and utilizes resilience metrics to maintain grid stability. For instance, during the hurricane event, the ability of the system to minimize outage times and adjust DER outputs to compensate for affected grid sections is highlighted. For peak demand management, the system architecture of the disclosure during a high demand period has the capacity to optimize DER usage, implement demand response strategies, and maintain voltage stability, thereby balancing demand with supply, reducing operational costs, and minimizing carbon emissions. For integration with renewable energy sources, the system architecture of the disclosure demonstrates its effectiveness in integrating high levels of renewable energy sources. The system architecture manages intermittent renewable generation, stores excess energy, and maintains grid resilience, all while ensuring a stable supply-demand balance.

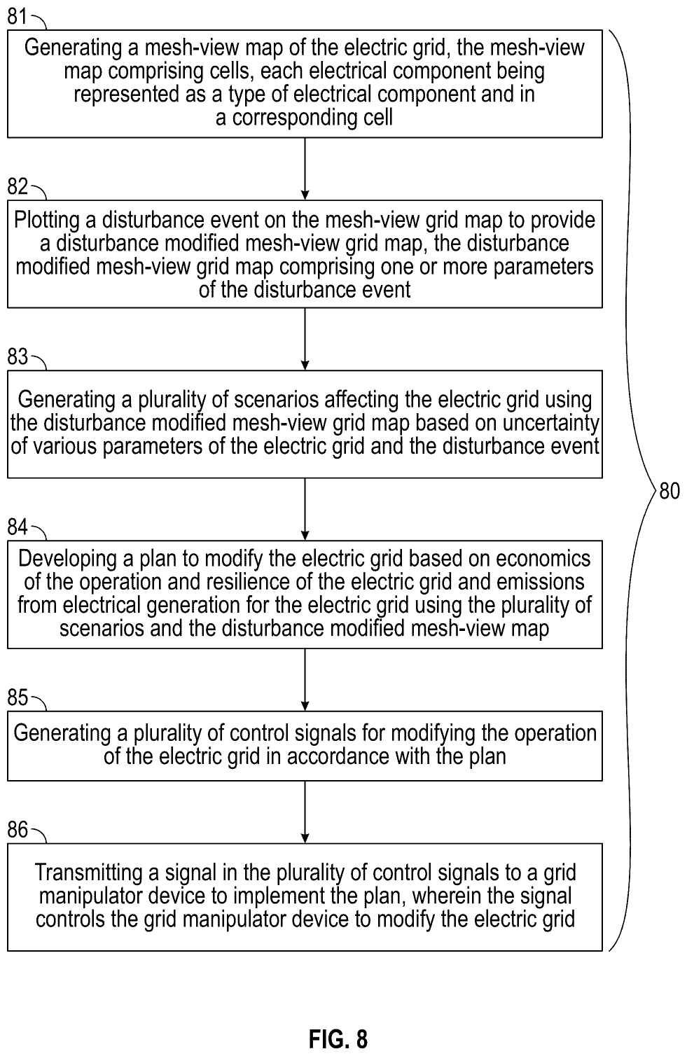

FIG. 8 is a flowchart for a method 80 for modifying an electric grid in response to a predicted or actual electric grid disturbance. Block 81 calls for generating a mesh-view map of an electric grid, the mesh-view map having cells, each electrical component being represented as a type of electrical component and in a corresponding cell. For example, a transformer would be identified as a transformer and be shown in a cell corresponding to its location. A transmission line would be identified as such and be shown traversing multiple cells from one end of the line to another end of the line. The cells may be formed by overlaying grid lines on the mesh-view map.

Block 82 calls for plotting a disturbance event on the mesh-view grid map to provide a disturbance modified mesh-view grid map, the disturbance modified mesh-view grid map having one or more parameters of the disturbance event. For example, a hurricane and its trajectory would be plotted on the mesh-view grid map to include wind speed and direction and rain fall amounts along the path of the trajectory of the hurricane.

Block 83 calls for generating a plurality of scenarios affecting the electric grid using the disturbance modified mesh-view grid map based on uncertainty of various parameters of the electric grid and the disturbance event.

Block 84 calls for developing a plan to modify the electric grid based on economics of operation and resilience of the electric grid and emissions from electrical generation for the electric grid using the plurality of scenarios and the disturbance modified mesh-view map. In one or more embodiments, this block may include one or more of the actions described in blocks 24-32 in FIG. 2 for developing the plan. As used herein, the term “emissions” relates to all emissions involved in the generation of electricity distributed by the electric grid. Non-limiting embodiments of emissions include carbon in various forms such as carbon dioxide, mercury, and nitrous oxides. Hence, any of the disclosed technology for reducing carbon emissions may also be used to reduce other types of emissions.

Block 85 calls for generating a plurality of control signals for modifying the operation of the electric grid in accordance with the plan.

Block 86 calls for transmitting a signal in the plurality of control signals to a grid manipulator device to implement the plan, wherein the signal controls the grid manipulator device to modify the electric grid.

The disclosure herein provides many advantages for managing an electric grid. The disclosure introduces features for energy community management, particularly in enhancing grid resilience, optimizing economic efficiency, and reducing environmental impact. These features are distinct from conventional grid management systems and offer a multi-faceted approach to address the complex challenges of modern power systems. Some of these advantages include the following.
Mesh-View Grid Mapping: This novel concept transforms the way energy communities visualize and analyze the impact of extreme events. By dividing the grid into a detailed matrix of two-dimensional cells, the method provides an unprecedented level of precision in identifying vulnerable areas within the EC. This granular approach is instrumental in developing highly effective resilience strategies tailored to the specific needs and vulnerabilities of different grid sections.
DER-Based ELCC Quantification: For grid resilience, the DER-based ELCC quantification method provides a reliable measure of the additional load capacity that DERs can support during emergencies, thereby quantifying their contribution to grid resilience in tangible terms. This method employs advanced reliability metrics like LOLP and LOLE, uniquely applied to the grid resilience context, setting a new benchmark in grid management practices.
Integrated Stochastic Scheduling: The multi-objective optimization model balances diverse grid management objectives. It integrates operational costs, resilience considerations, and carbon emissions into a cohesive framework. This integration is further enriched by the incorporation of stochastic elements such as fluctuating market prices and variable renewable energy outputs, mirroring the complexity and unpredictability of real-world grid management scenarios.

The features introduced in this disclosure improve grid management technology, offering clear and measurable improvements over existing methodologies. These features are discussed as follows.
Enhancements in Resilience: Traditional grid management systems often fall short in accurately predicting and effectively responding to the impacts of extreme events. The mesh-view grid mapping and DER-based ELCC quantification in this disclosure fill this gap by enabling precise impact analysis and quantifying capacity of DERs in emergencies. This leads to faster, more efficient response strategies, significantly bolstering the resilience of energy communities.
Economic Optimization: In contrast to conventional systems that may prioritize singular objectives, often leading to higher operational costs, the integrated stochastic scheduling model in this disclosure strikes an optimal balance between cost, resilience, and sustainability. This approach ensures that resources are utilized in the most economically efficient manner, reducing unnecessary expenditures and enhancing overall system performance.
Reduced Environmental Impact: The integration of carbon emission metrics into the optimization process highlights the commitment to environmental sustainability by the grid management system. It effectively aligns with global sustainability goals by promoting the use of renewable resources and minimizing the carbon footprint of energy communities. This environmental aspects sets the system architecture apart from many traditional grid management technologies, which often overlook the critical aspect of environmental impact in their operational strategies.

The electric grid management system may include Advanced Predictive Analytics as discussed below.
Machine Learning and AI Integration: The application of machine learning algorithms and AI can significantly enhance the predictive capabilities of the electric grid management system. By analyzing historical data and identifying patterns, these technologies can forecast potential grid disruptions, allowing for more proactive and effective grid management strategies. Implementation of AI within the electric grid management system is not isolated and is fully integrated into the broader grid management framework, leading to utilization of the complete menu of AI capabilities within the framework. The use of AI within the framework provides improvements in predicting energy demand and optimizing resource allocation.
Predictive Maintenance Using Internet of Things (IoT) Data: The integration of IoT devices across the grid can provide real-time data for predictive maintenance. Machine learning algorithms can analyze this data to predict equipment failures before they occur, reducing downtime and maintenance costs.

The electric grid management system may be integrated with Electric Vehicle Networks as discussed below.
Smart Charging Infrastructure: Developing advanced algorithms for the intelligent charging of electric vehicles (EVs) can optimize energy usage and support grid stability during peak demand periods.
Vehicle-to-Grid (V2G) Systems: V2G systems can enable EVs to not only draw energy from the electric grid but also supply energy back during times of high demand or grid instability, functioning as mobile energy storage units.

The electric grid management system may be integrated with Diverse Renewable Energy Sources as discussed below.
Varying Renewable Sources: Integrating different types of renewable energy sources, such as solar, wind, hydro, and geothermal, can optimize the energy mix for enhanced resilience and sustainability.
Hybrid Renewable Energy Systems: Hybrid systems that combine multiple renewable energy sources can ensure a more consistent and reliable energy supply, thereby reducing dependence on traditional fossil fuels.

The electric grid management system may be integrated with Smart Home Technologies as discussed below.
Smart Grids and Smart Homes: The synergy between smart electric grids and smart home technologies can lead to more efficient energy management at both the community and individual household levels.
Demand Response Programs: Implementing advanced demand response programs that leverage smart home devices can optimize energy consumption patterns, reduce peak loads, and contribute to overall grid stability.

The electric grid management system may be integrated with Climate Change Adaptation Strategies as discussed below.
Resilience Against Climate-Induced Events: Strategies to adapt to climate change-induced extreme weather events can enhance the resilience of energy communities against such unpredictable occurrences.
Sustainable Urban Energy Planning: Focusing on sustainable urban energy planning that considers the impact of urbanization and climate change can lead to more resilient and environmentally friendly urban energy infrastructures.
Innovative Integration of DERs: The system architecture integrates DERs within ECs, enhancing grid resilience. This integration is useful in the context of extreme events, where traditional energy systems may falter.
Mesh-View Grid Mapping: The introduction of mesh-view grid mapping provides precision in analyzing and predicting the impact of extreme events, ensuring targeted resilience strategies and effective resource utilization.
DER-Based ELCC Quantification: The approach of the grid management system to quantifying the ELCC of DERs calculates the additional load that DERs can reliably support during emergencies, strengthening the grid's resilience and reliability.
Multi-Objective Optimization Framework: The optimization model balances operational cost, resilience, and carbon emissions and is a multi-faceted approach that ensures a balanced and sustainable management of the energy grid.

The electric grid management system provides several societal impacts as discussed below.
Grid Modernization and Sustainability: The disclosure plays a role in the modernization of energy grids. By integrating advanced technologies and renewable energy sources, it enables more sustainable and efficient energy systems.
Resilience Against Climate Change: The resilience provided by the grid management system in the face of extreme weather events and climate change-induced disruptions equips energy communities with the tools and strategies to withstand and quickly recover from such events.
Economic and Environmental Benefits: The emphasis of the grid management system on economic efficiency and reduced carbon emissions aligns with global sustainability goals. It offers a model for future energy systems that are not only resilient but also economically viable and environmentally responsible.
Scalability and Adaptability: The flexibility and scalability of the grid management system make it suitable for a wide range of applications and adaptable to various geographical and infrastructural conditions. This adaptability is essential for widespread adoption and long-term impact.

Generally, as discussed herein, the term “real time” refers to functions that occur in a temporal context (i.e., time) that is responsive to a particular system need. For example, sensing may occur in a periodic frequency of seconds, minutes, or hours. In some instances, such as with monitoring voltage, it may be desired to have ongoing sensing that occurs in periods of seconds or fractions thereof. In contrast, it may be adequate to sense aspects such as ambient temperature or humidity every hour or a fraction thereof. Accordingly, the term “real time” is not to be construed to require instantaneous function, but that period that is adequate for performance of the functions described herein.

In support of the teachings herein, various analysis components may be used, including a digital and/or an analog system. For example, the computer processing system 10, controller 14, grid manipulator device 15, and/or the sensor 9 may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The conjunction “or” when used with a list of at least two terms is intended to mean any term or combination of terms. The conjunction “and/or” when used between two terms is intended to mean both terms or any individual term. The term “configured” relates one or more structural limitations of a device that are required for the device to perform the function or operation for which the device is configured. The terms “first” and “second” and the like are not intended to denote a particular order but rather are intended to distinguish elements. The term “exemplary” is not intended to be construed as a superlative example but merely one of many possible examples.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The technology disclosed herein may be practiced in at least some embodiments with a set of elements as claimed or set forth. In some other embodiments, the technology may be enhanced by including additional elements to provide additional benefits.

While one or more embodiments have been shown and described, modifications and substitutions may be made thereto without departing from the scope of the invention. Accordingly, it is to be understood that the present invention has been described by way of illustrations and not limitations.

It will be recognized that the various components or technologies may provide certain necessary or beneficial functionality or features. Accordingly, these functions and features as may be needed in support of the appended claims and variations thereof are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for modifying an operation of an electric grid comprising electrical components, the system comprising:
a processor configured to execute instructions stored on a non-transitory medium, the instructions implementing a method comprising:
generating a mesh-view map of the electric grid, the mesh-view map comprising cells, each electrical component being represented as a type of electrical component and in a corresponding cell;
plotting a disturbance event on the mesh-view map to provide a disturbance modified mesh-view map, the disturbance modified mesh-view map comprising one or more parameters of the disturbance event;
generating a plurality of scenarios affecting the electric grid using the disturbance modified mesh-view map based on uncertainty of various parameters of the electric grid and the disturbance event;
developing a plan to modify the operation of the electric grid based on at least economics of operation and resilience of the electric grid and emissions from electrical generation for the electric grid using the plurality of scenarios and the disturbance modified mesh-view map;
generating a plurality of control signals for modifying the operation of the electric grid in accordance with the plan;
a grid manipulator device configured to modify the electric grid in response to receiving a signal in the plurality of control signals from the processor to implement the plan.

2. The system according to claim 1, wherein the grid manipulator device is a remote-controlled switch configured to connect or disconnect at least one of the electrical components to or from the electric grid.

3. The system according to claim 1, further comprising a controller in communication with a distributed energy source and configured to transmit a signal to activate the distributed energy source upon receiving a signal in the plurality of control signals from the processor to implement the plan, wherein the distributed energy source comprises at least one of a fossil-fuel electric generator, a hydro-powered generator, a wind turbine, a solar panel, and an energy storage facility.

4. The system according to claim 1, wherein developing a plan comprises training an artificial intelligence (AI) algorithm using input data that is received by a computer processing system that comprises the processor and using the AI algorithm to develop the plan by predicting potential disruptions of the electric grid due to the disturbance event.

5. The system according to claim 1, further comprising a controller configured to transmit an alert signal in response to the processor developing the plan.

6. The system according to claim 1, wherein generating a plurality of scenarios affecting the electric grid comprises identifying parameters with associated uncertainties and varying the parameters using a uniform distribution function for Monte Carlo simulations.

7. The system according to claim 6, wherein developing a plan comprises modeling resilience, carbon emissions, two-stage stochastic scheduling, and effective load-carrying capability (ELCC) of the electric grid for the plurality of scenarios, the two-stage stochastic modeling comprising a real time response stage and a prediction planning stage.

8. The system according to claim 7, wherein developing a plan further comprises integrating the resilience modeling, the carbon emissions modeling, and the ELCC modeling into the two-stage stochastic modeling to provide an integrated two-stage stochastic model and developing a tri-objective economic, resilience, and carbon emission optimization problem using the integrated two-stage stochastic model.

9. The system according to claim 8, wherein developing a plan further comprises modeling the tri-objective optimization problem as a mixed-integer linear programming (MILP) model comprising defined constraints and decision variables representing grid operational parameters and resilience metrics.

10. The system according to claim 9, wherein developing further comprises solving the MILP model and extracting a Pareto optimal of non-dominated solutions to provide a set of proposed modifications to the electric grid that optimally balance the economic, resilience, and carbon emission objectives.

11. The system according to claim 9, wherein the plurality of control signals from the processor implements one or more proposed modifications to the electric grid derived from the MILP model solutions.

12. The system according to claim 1, wherein the processor is further configured to plot the disturbance event and at least one associated parameter on the mesh-view grid map comprising at least one of event trajectory, displacement speed, or intensity.

13. The system according to claim 12, wherein the disturbance event comprises at least one of a storm, a hurricane, a tornado, sub-freezing temperatures, a wildfire, or an earthquake.

14. The system according to claim 13, wherein the at least one associated parameter comprises at least one of a trajectory of the disturbance event, a displacement speed of the disturbance event, a temperature, a barometric pressure, a wind speed, or an acceleration.

15. The system according to claim 1, further comprising a sensor in communication with the processor and configured to monitor operational data related to electric grid operations.

16. A non-transitory computer readable medium comprising instructions for modifying an operation of an electric grid comprising electrical components that when executed by a processor implements a method comprising:
generating a mesh-view map of the electric grid, the mesh-view map comprising cells, each electrical component being represented as a type of electrical component and in a corresponding cell;
plotting a disturbance event on the mesh-view grid map to provide a disturbance modified mesh-view grid map, the disturbance modified mesh-view grid map comprising one or more parameters of the disturbance event;
generating a plurality of scenarios affecting the electric grid using the disturbance modified mesh-view grid map based on uncertainty of various parameters of the electric grid and the disturbance event;
developing a plan to modify the operation of the electric grid based on economics of operation and resilience of the electric grid and emissions from electrical generation for the electric grid using the plurality of scenarios and the disturbance modified mesh-view map;
generating a plurality of control signals for modifying the operation of the electric grid in accordance with the plan; and
transmitting a signal in the plurality of control signals to a grid manipulator device to implement the plan, wherein the signal controls the grid manipulator device to modify the electric grid.

17. The non-transitory computer readable medium according to claim 16, wherein generating a plurality of scenarios affecting the electric grid comprises identifying parameters comprising an uncertainty and varying the parameters according to a uniform distribution function using Monte Carlo simulations.

18. The non-transitory computer readable medium according to claim 17, wherein developing a plan comprises modeling resilience, carbon emissions, two-stage stochastic scheduling, and effective load-carrying capability (ELCC) of the electric grid for the plurality of scenarios, the two-stage stochastic modeling comprising a real time stage and a prediction stage.

19. The non-transitory computer readable medium according to claim 16, wherein developing a plan further comprises:
integrating the resilience modeling, the carbon emission modeling, and the ELCC modeling into the two-stage stochastic modeling to provide an integrated two-stage stochastic model;
developing a tri-objective economic, resilience, and carbon emissions optimization problem using the integrated two-stage stochastic model;
modeling the tri-objective economic, resilience, and carbon emission optimization problem as a mixed-integer linear programming model; and
solving the mixed-integer linear programming model and extracting a Pareto optimal of non-dominated solutions to provide an optimal solution, the optimal solution comprising a proposed modification to operation of the electric grid.

20. A system for modifying an electric grid comprising electrical components, the system comprising:
a processor configured to execute instructions, the instructions comprising:
generating a mesh-view map of the electric grid, the mesh-view map comprising cells, each electrical component being represented as a type of electrical component and in a corresponding cell;
plotting a disturbance event on the mesh-view grid map to provide a disturbance modified mesh-view grid map, the disturbance modified mesh-view grid map comprising one or more parameters of the disturbance event;
developing a plan to modify the operation of the electric grid based on economics of the operation and resilience of the electric grid and emissions of electrical generation for the electric grid using the disturbance modified mesh-view map;
generating a plurality of control signals for modifying the operation of the electric grid in accordance with the plan;
a controller in communication with the processor and configured to transmit a signal to at least one of a grid manipulator or a distributed energy resource upon receiving a control signal in the plurality of control signals from the processor to implement the plan; and
a sensor in communication with the processor and configured to sense a parameter related to at least one of any electrical component in the electric grid or the disturbance event to provide feedback as to operation of the electric grid.
